(19) United States
(12) Patent Application Publication
(10) Pub. No.: US 2025/0365212 A1
(43) Pub. Date: Nov. 27, 2025

(54) PROTECTING MACHINE LEARNING MODELS IN A WIRELESS COMMUNICATION NETWORK

(71) Applicant: Lenovo (Singapore) Pte. Ltd., Singapore (SG)

(72) Inventors: Andreas KUNZ, Ladenburg (DE); Dimitrios KARAMPATSIS, Middlesex (GB); Sheeba Backia Mary BASKARAN, Friedrichsdorf (DE)

(21) Appl. No.: 18/874,785

(22) PCT Filed: Aug. 8, 2022
(86) PCT No.: PCT/EP2022/072209

§ 371 Date: Dec. 13, 2024

(30) Foreign Application Priority Data
Jun. 15, 2022 (GR) 20220100494

(51) Int. Cl. H04L 41/16; H04L 41/14

(52) U.S. Cl. CPC H04L 41/16; H04L 41/145

(57) ABSTRACT

There is provided a method in a Network Data Analytics Function containing a Model Training logical function. The method comprises receiving a machine learning (ML) model provision request, the ML model provision request comprising: an identifier for at least one Analytic, and, ML model file specific information, and generating a protected trained ML model using a stored security context. The method further comprises sending, in response to the ML model provision request, an ML model provision response message, the ML model provision response message comprising: the identifier for the at least one Analytic; at least one protected trained ML model file; and location information of the stored security context.

### FIELD

The subject matter disclosed herein relates generally to the field of implementing protecting machine learning models in a wireless communication network. This document defines a method in a Network Data Analytics Function containing a Model Training logical function, a Network Data Analytics Function containing a Model Training logical function, a method in a data collector, and a data collector.

### BACKGROUND

Artificial Intelligence and Machine Learning (AI/ML) models, herein referred to as ML models, are employed in 3GPP wireless communication networks. There is a need to store Machine Learning (ML) model data and related information in a repository, such as the ADRF (Analytics Data Repository Function). It has been identified that if there is no protection against accessing and reading an AI/ML model from the ADRF, a compromised ADRF may expose algorithms and sensitive data to a non-authorized entity which can easily misuse it and/or distribute it to other entities, causing a bigger data security breach. 3GPP TR 33.738 V0.1.0 (2022-05), is titled “Study on security aspects of enablers for Network Automation for 5G” (Release 18). 3GPP TR 23.700-81 V0.3.0 (2022-05), is titled “Study of Enablers for Network Automation for 5G, 5G System (5GS)” (Release 18). These describe how trained ML models may be stored to and/or retrieved from an ADRF.

### SUMMARY

A problem with the available solutions is that they leave the ML model data between Network Function producer (NFp) and Network Function consumer (NFc) exposed. Further, the ML model data may be exposed to attack when being stored in the ADRF.

Disclosed herein are procedures for protecting machine learning models in a wireless communication network. Said procedures may be implemented by Network Data Analytics Function containing a Model Training logical function or a data collector.

Accordingly, there is provided a method in a Network Data Analytics Function containing a Model Training logical function. The method comprises receiving a machine learning (ML) model provision request, the ML model provision request comprising: an identifier for at least one Analytic, and, ML model file specific information, and generating a protected trained ML model using a stored security context. The method further comprises sending, in response to the ML model provision request, an ML model provision response message, the ML model provision response message comprising: the identifier for the at least one Analytic; at least one protected trained ML model file; and location information of the stored security context.

There is further provided a Network Data Analytics Function containing a Model Training logical function and comprising a transceiver and a processor. The transceiver is arranged to receive a machine learning (ML) model provision request, the ML model provision request comprising: an identifier for at least one Analytic, and ML model file specific information. The processor is arranged to generate a protected trained ML model using a stored security context. The transceiver is further arranged to send, in response to the ML model provision request, an ML model provision response message, the ML model provision response message comprising: the identifier for the at least one Analytic; at least one protected trained ML model file; and location information of the stored security context.

There is further provided a method in a data collector. The method comprises receiving a storage request from a Network Data Analytics Function containing a Model Training logical function, the storage request comprising a protected trained ML model and a security context used to protect the trained ML model. The method further comprises storing the received security context in a local storage; and sending the protected trained ML model to an Analytics Data Repository Function for storage.

There is further provided a data collector comprising a transceiver and a local memory. The transceiver is arranged to receive a storage request from a Network Data Analytics Function containing a Model Training logical function, the storage request comprising a protected trained ML model and a security context used to protect the trained ML model. The local memory is arranged to store the received security context. The transceiver is further arranged to send the protected trained ML model to an Analytics Data Repository Function for storage.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for protecting machine learning models in a wireless communication network will now be described, by way of example only, with reference to the accompanying drawings, in which:

FIG. 1 depicts an embodiment of a wireless communication system for protecting machine learning models in a wireless communication network;

FIG. 2 depicts a user equipment apparatus;

FIG. 3 depicts further details of a network node;

FIG. 4 illustrates an arrangement wherein a Trained Model is requested by AnLF;

FIG. 5 illustrates a method of operation of an NWDAF containing MTLF;

FIG. 6 illustrates an arrangement wherein a security context is generated in an NWDAF MTLF, but stored in Key Management Server;

FIG. 7 illustrates a method of operation of an NWDAF containing MTLF;

FIG. 8 illustrates a method of operation of a KMS;

FIG. 9 illustrates an arrangement wherein a security context is generated and stored in an NWDAF containing MTLF;

FIG. 10 illustrates a method of operation of an NWDAF containing MTLF;

FIG. 11 illustrates a method wherein a security context is generated by a key management server;

FIG. 12 illustrates a method of operation of a KMS;

FIG. 13 illustrates a method wherein a security context is stored at a data collector;

FIG. 14 illustrates a method of operation of a data collector, for example a DCCF/MFAF or an NRF;

FIG. 15 illustrates a method in a Network Data Analytics Function containing a Model Training logical function; and

FIG. 16 illustrates a method in a data collector.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an crasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

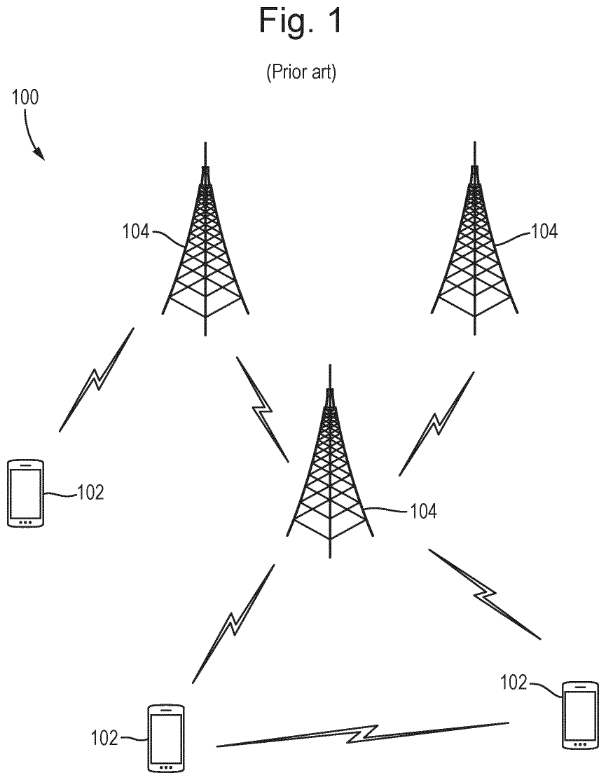

FIG. 1 depicts an embodiment of a wireless communication system 100 for protecting machine learning models in a wireless communication network. In one embodiment, the wireless communication system 100 includes remote units 102 and network units 104. The network units 104 may each comprise a network node 300 as described herein. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving arca, for example, a cell or a cell sector via a wireless communication link. The network units 104 transmit DL communication signals to serve the remote units 102 in the time, frequency, and/or spatial domain.

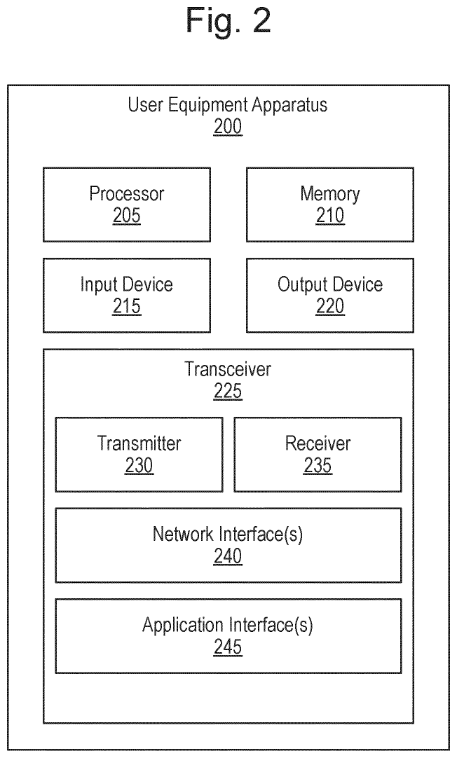

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communications network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

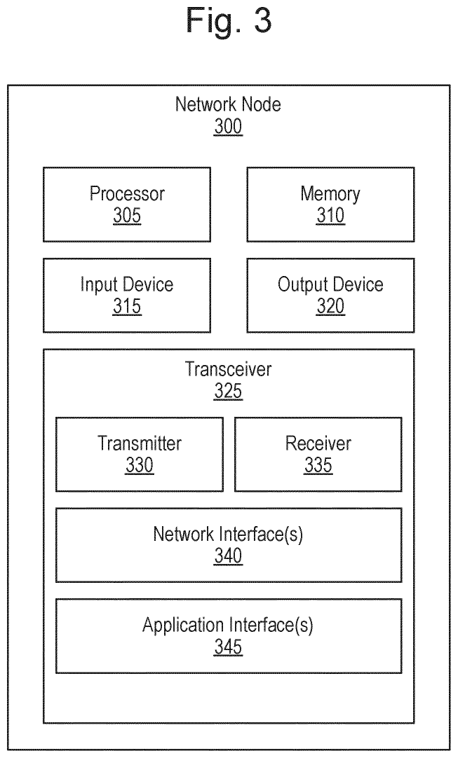

FIG. 3 depicts further details of the network node 300 that may be used for implementing the methods described herein. The network node 300 may comprise a network unit 104, a NWDAF MTLF 430, a NWDAF MTLF 630, a NWDAF MTLF 930, a NWDAF MTLF 1130, a NWDAF MTLF 1330, a DCCF/MFAF 1315, an NRF 625, an NRF 935, an NRF 1125, or an NRF 1325 as described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

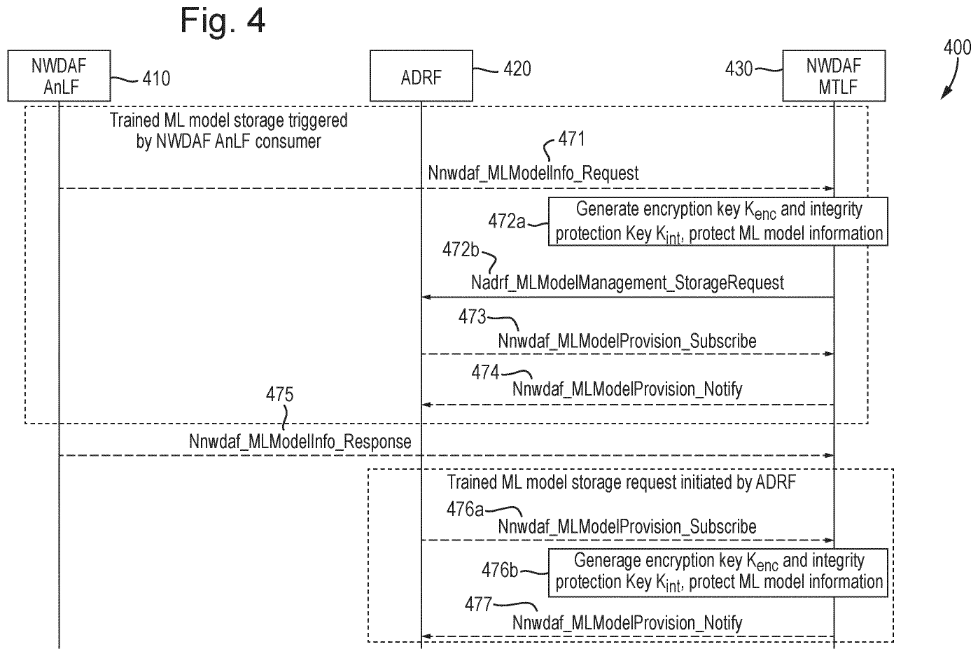

FIG. 4 illustrates an arrangement wherein a Trained Model is requested by AnLF, MTLF encrypts ML data and stores it in the ADRF, provides the key to AnLF. FIG. 4 illustrates a Network Data Analytics Function containing an Analytics logical function (NWDAF AnLF) 410, an Analytics Data Repository Function (ADRF) 420 and a Network Data Analytics Function containing a Model Training logical function (NWDAF MTLF) 430. The NWDAF MTLF 430 may comprise a network node 300 as described herein.

At step 471, the NWDAF containing AnLF 410 sends Nnwdaf_MLModelInfo_Request with the following input parameters Analytics ID(s), ML model file specific information (ML model file serialization format), Notification end point address (ADRF) to the NWDAF containing MTLF 430.

At step 472a, the NWDAF containing MTLF 430 generates a security context comprising an encryption key K_{enc} and/or and integrity key Kᵢₙₜ and selects a security algorithm for encryption and/or integrity protection, i.e. either the same algorithm for both, or a different for each. Alternatively, the security context may only operate to protect either encryption or integrity. The key generation may be based on algorithms known in the state of the art. The NWDAF containing MTLF 430 uses the encryption key K_{enc} and/or and integrity key Kᵢₙₜ to protect the ML model and/or related information, c.g. ML model file serialization format etc.

At step 472b, the NWDAF containing MTLF 430 sends Nadrf_MLModelManagement_StorageRequest to the ADRF 420. The Nadrf_MLModelManagement_StorageRequest has input parameters Analytics ID(s), Protected Trained ML model file(s), ML model file specific information (ML model file serialization format).

At step 473, the ADRF 420 subscribes to ML model training update with the NWDAF containing MTLF 430. The ADRF 420 sends Nnwdaf_MLModelProvision_Subscribe with input parameters Analytics ID(s), ML model file specific Information (ML model file serialization format).

At step 474, when the ML model for which the ADRF 420 has subscribed for ML model training update has been updated, the NWDAF containing MTLF 430 sends Nnwdaf_MLModelProvision_Notify with following parameters Analytics ID, Protected Trained ML model file, Notification Correlation ID.

At step 475, the NWDAF containing MTLF 430 sends Nnwdaf_MLModelInfo_Response with the following parameters Analytics ID(s), Protected Trained ML model file address, encryption key K_{enc} and/or and integrity key Kᵢₙₜ, security algorithm(s), ADRF storage status which indicates if the ML model storage requested in step 471 was successful or failed.

If trained ML model(s) storage in ADRF 420 is initiated by ADRF then steps 476a, 476b and 477 are performed. The trigger to initiate storage of trained ML model(s) from NWDAF MTLF 430 is followed by steps 476a, 476b and 477.

At step 476a, the ADRF 420 sends Nnwdaf_MLModelProvision_Subscribe with the following input parameters ML model file specific information (ML model file serialization format).

At step 476b. The NWDAF containing MTLF generates a security context. The security context may comprise an encryption key K_{enc} and/or and integrity key Kᵢₙₜ and selects a security algorithm for encryption and/or integrity protection, i.e. either the same algorithm for both, or a different for each, or only for protecting with encryption or integrity. Within the security context, instead of a symmetric key, also an unsymmetric security scheme may be used, e.g. public-private key pair, where integrity protection is performed in terms of a hash over the ML model, which is then encrypted with the private key. The public key can be then used to decrypt the hash and to verify the computed hash result at the receiver. If the NWDAF containing MTLF is pre-provisioned with the security context, e.g. from the NRF/DCCF etc., then the NWDAF containing MTLF does not need to generate a new security context. The key generation may be based on algorithms known in the state of the art. The NWDAF containing MTLF uses the encryption key K_{enc} and/or and integrity key Kᵢₙₜ. to protect the ML model and/or related information, e.g. ML model file serialization format etc.

At step 477, the NWDAF containing MTLF 430 sends Nnwdaf_MLModelProvision_Notify with the following input parameters Analytics ID, Protected Trained ML model file, Notification Correlation ID.

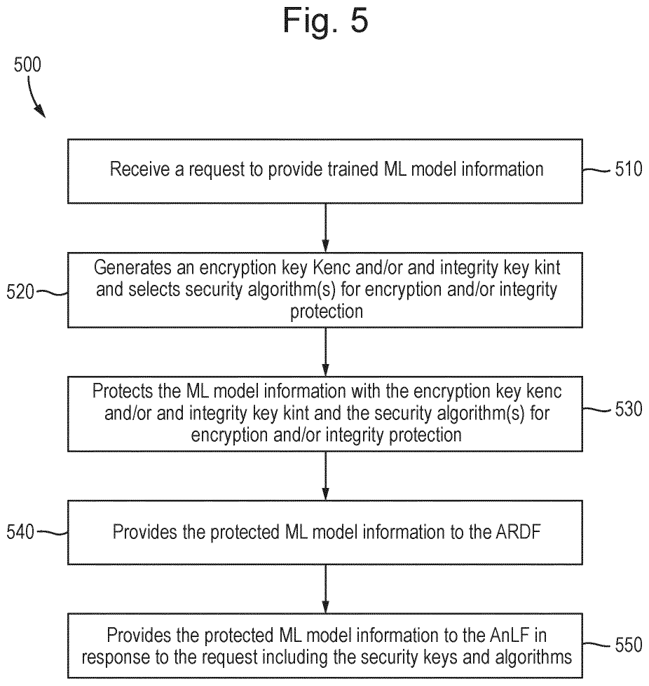

FIG. 5 illustrates a method 500 of operation of an NWDAF containing MTLF 430 as illustrated in FIG. 4. In overview, a trained Model is requested by AnLF to ADRF, MTLF encrypts ML data and stores it in the ADRF, provides the key to Key Management Function. The method 500 comprises receiving 510 a request to provide trained ML model information. The method 500 further comprises generating 520 an encryption key K_{enc} and/or and integrity key Kᵢₙₜ and selects security algorithm(s) for encryption and/or integrity protection. The method 500 further comprises Protecting 530 the ML model information with the encryption key K_{enc} and/or and integrity key Kᵢₙₜ and the security algorithm(s) for encryption and/or integrity protection. The method 500 further comprises providing 540 the protected ML model information to the ARDF. The method 500 further comprises providing 550 the protected ML model information to the AnLF in response to the request including the security keys and algorithms.

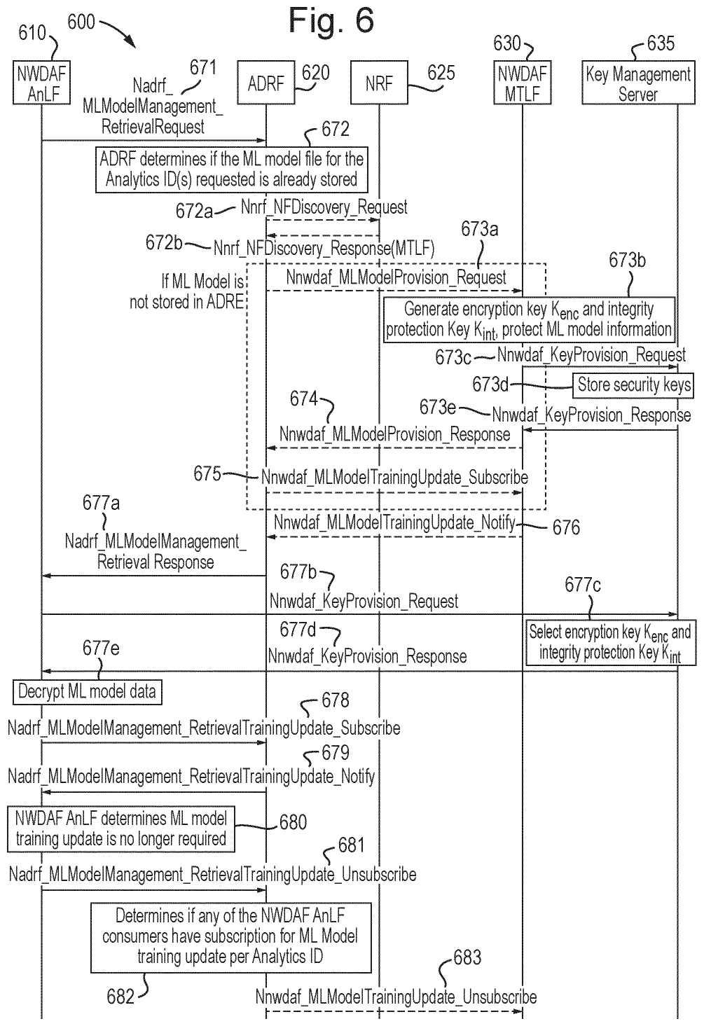

FIG. 6 illustrates an arrangement wherein a security context is generated in an NWDAF MTLF but stored in a Key Management Server (KMS). FIG. 6 illustrates a Network Data Analytics Function containing an Analytics logical function (NWDAF AnLF) 610, an Analytics Data Repository Function (ADRF) 620, a Network Repository Function (NRF) 630, a Network Data Analytics Function containing a Model Training logical function (NWDAF MTLF) 630, and a Key Management Server (KMS) 635. The NWDAF MTLF 630 may comprise a network node 300 as described herein.

A method 600 begins at step 471, where the NWDAF containing AnLF 610 sends Nadrf_MLModelManagement_RetrievalRequest which includes Analytics ID(s), ML Model Filter Info (ML model file specific information), optionally Target NF (NWDAF containing MTLF) to subscribe for notifications. The ML model file specific information includes the ML model file serialization format requested by the NWDAF containing AnLF 610.

At 672, the ADRF 620 determines if the ML model file for the Analytics ID(s) requested is already stored. This is done by way of the ADRF 620 sending 672a a Nnrf_NFDiscovery_Request to the NRF 625. In response the NRF 625 sends 672b a Nnrf_NFDiscovery_Response message to the ADRF 620, the Nnrf_NFDiscovery_Response message identifying the MTLF. If the ML model file for the Analytics ID(s) requested in not stored in ADRF 620 then steps 673, 674, 675, and 676 are performed, before these steps, the ADRF 620 discovers the target MTLF 630 from the NRF 625 optionally if it isn't informed by the AnLF 610 in the step 671. If the ML model file for the Analytics ID(s) requested is stored in ADRF 620 the steps 673, 674, 675, and 676 are skipped.

At 673a, the ADRF 620 sends Nnwdaf_MLModelProvision_Request with the input parameters defined in TS 23.288 and additional input parameters ML model file specific information (ML model file serialization format).

At 673b, the NWDAF containing MTLF 630 generates a security context comprising an encryption key K_{enc} and/or and integrity key Kᵢₙₜ and selects a security algorithm for encryption and/or integrity protection, i.e. either the same algorithm for both, or a different for each, or only for protecting with encryption or integrity. The key generation may be based on algorithms known in the state of the art. The NWDAF containing MTLF 630 uses the encryption key K_{enc} and/or and integrity key Kᵢₙₜ to protect the ML model and/or related information, e.g. ML model file serialization format etc.

At 673c, the NWDAF containing MTLF 630 sends Nnwdaf_KeyProvision_Request to the KMS 635 with the input parameters Analytics ID(s), Notification Correlation ID, encryption key K_{enc} and/or and integrity key Kᵢₙₜ. The KMS address may be preconfigured in NWDAF containing MTLF 630 or discovered via NRF 625.

At 673d, the KMS 635 stores the security keys and the related ML information for identification.

At 673c, the KMS 635 sends a Nnwdaf_KeyProvision_Response to the NWDAF containing MTLF 630, indicating a successful storage of the information.

At 674, the NWDAF containing MTLF 630 sends a Nnwdaf_MLModelProvision_Response with following parameters Analytics ID(s), Protected Trained ML model file(s), KMS address. The KMS address maybe the NF identifier of the KMS 635, used to authorize another consumer to contact the KMS 635 via the NRF 625.

At 675, the ADRF 620 sends Nnwdaf_MLModelTrainingUpdate_Subscribe with the input parameters Analytics ID(s), ML model file specific information (ML model file serialization format).

At 676, when the ML model for which the ADRF has subscribed for ML model training update has been updated, the NWDAF containing MTLF 630 sends Nnwdaf_MLModelTrainingUpdate_Notify with the following parameters Analytics ID, Protected Trained ML model(s) file, Notification Correlation ID, KMS address.

At 677a, the ADRF 620 sends a response back to NWDAF containing AnLF 610 using Nadrf_MLModelManagement_Retrieval Response with the following parameters ML Model File Information (Trained ML model(s) file, ML model file serialization format, Trained ML Model ID per Analytics ID, KMS address).

At 677b, the NWDAF containing AnLF 610 sends Nnwdaf_KeyProvision_Request to the KMS 635 with the input parameters Analytics ID(s), Notification Correlation ID. The NWDAF containing AnLF may be authorized by the NRF 625 to contact the KMS 635.

At 677c, the KMS 635 selects the security keys based on the related ML information for identification.

At 677d, the KMS 635 sends a Nnwdaf_KeyProvision_Response to the NWDAF containing AnLF 610, including the encryption key K_{enc} and/or and integrity key Kᵢₙₜ, security algorithm(s).

At 677c, the NWDAF containing AnLF 610 unprotects the ML model data with the received security keys. The unprotection may comprise a de-encryption.

At 678, the NWDAF containing AnLF 610 subscribes to ADRF 620 using Nadrf_MLModelManagement_RetrievalTrainingUpdate_Subscribe service operation containing input parameters Trained ML Model ID per Analytics ID.

At 679. The ADRF 620 sends a notification to NWDAF containing AnLF 610 using Nadrf_MLModelManagement_RetrievalTrainingUpdate_Notify service operation containing following parameters ML Model File Information (Protected Trained ML model(s) file, ML model file serialization format, Trained ML Model ID per Analytics ID, KMS address).

At 680, the NWDAF containing AnLF 610 determines that the ML model training update is no longer required.

At 681, the NWDAF containing AnLF 610 sends Nadrf_MLModelManagement_RetrievalTrainingUpdate_Unsubscribe with Subscription Correlation ID as input parameters.

At 682, the ADRF 620 determines if any of the NF consumer(s) have subscription for ML Model training update per Analytics ID. If none of the NF consumer(s) have subscription for ML model training update per Analytics ID, the ADRF 620 removes the ML model file and ML model file specific information and proceed to step 679.

At 683, the ADRF 620 sends Nnwdaf_MLModelTrainingUpdate_Unsubscribe to NWDAF containing MTLF 630 with the Subscription Correlation ID as input parameter.

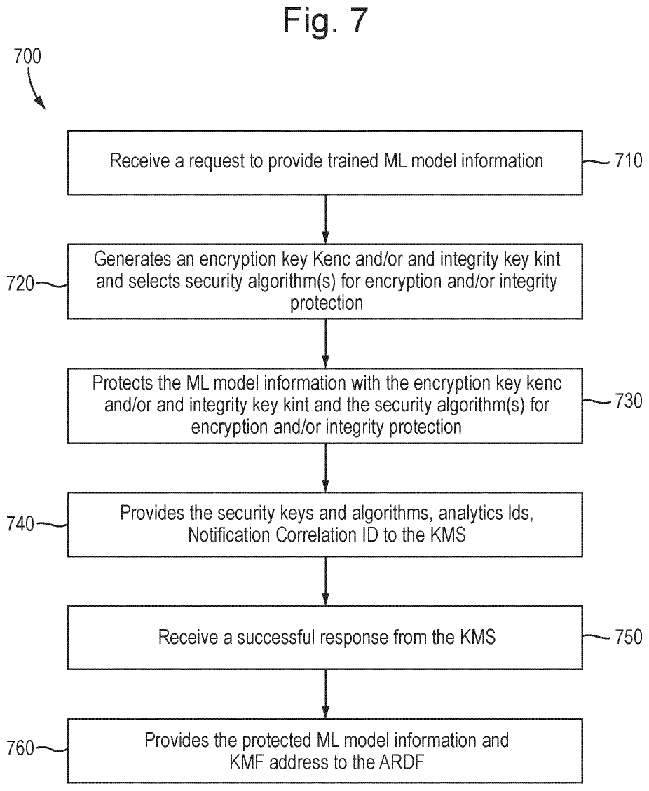

FIG. 7 illustrates a method 700 of operation of an NWDAF containing MTLF, for example 630 illustrated in FIG. 6. The method 700 comprises Receiving 710 a request to provide trained ML model information. The method 700 further comprises generating 720 an encryption key K_{enc} and/or and integrity key Kᵢₙₜ and selects security algorithm(s) for encryption and/or integrity protection. The method 700 further comprises protecting 730 the ML model information with the encryption key K_{enc} and/or and integrity key Kᵢₙₜ and the security algorithm(s) for encryption and/or integrity protection. The method 700 further comprises providing 740 the security keys and algorithms, analytics Ids, Notification Correlation ID to the KMS. The method 700 further comprises receiving 750 a successful response from the KMS. The method 700 further comprises providing 760 the protected ML model information and KMS address to the ARDF.

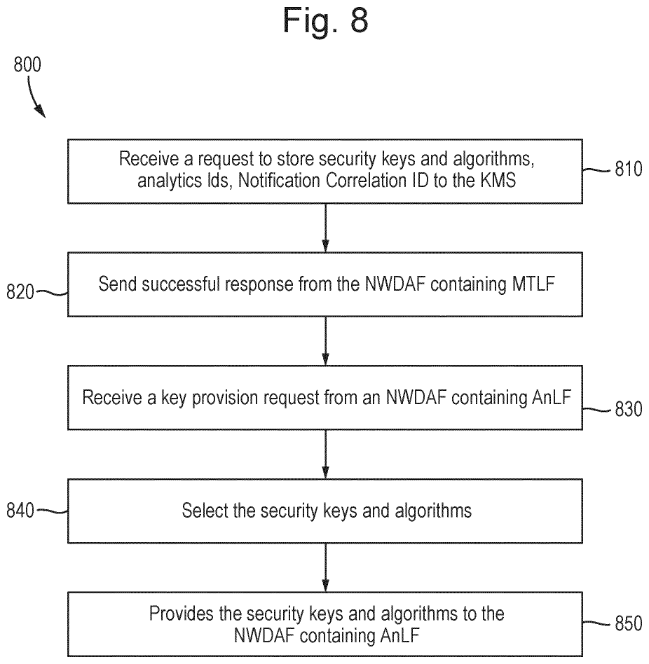

FIG. 8 illustrates a method 800 of operation of a KMS, for example 635 illustrated in FIG. 6. The method 800 comprises receiving 810 a request to store security keys and algorithms, analytics Ids, Notification Correlation ID to the KMS. The method 800 further comprises sending 820 a successful response from the NWDAF containing MTLF. The method 800 further comprises receiving 830 a key provision request from an NWDAF containing AnLF. The method 800 further comprises selecting 840 the security keys and algorithms. The method 800 further comprises providing 850 the security keys and algorithms to the NWDAF containing AnLF.

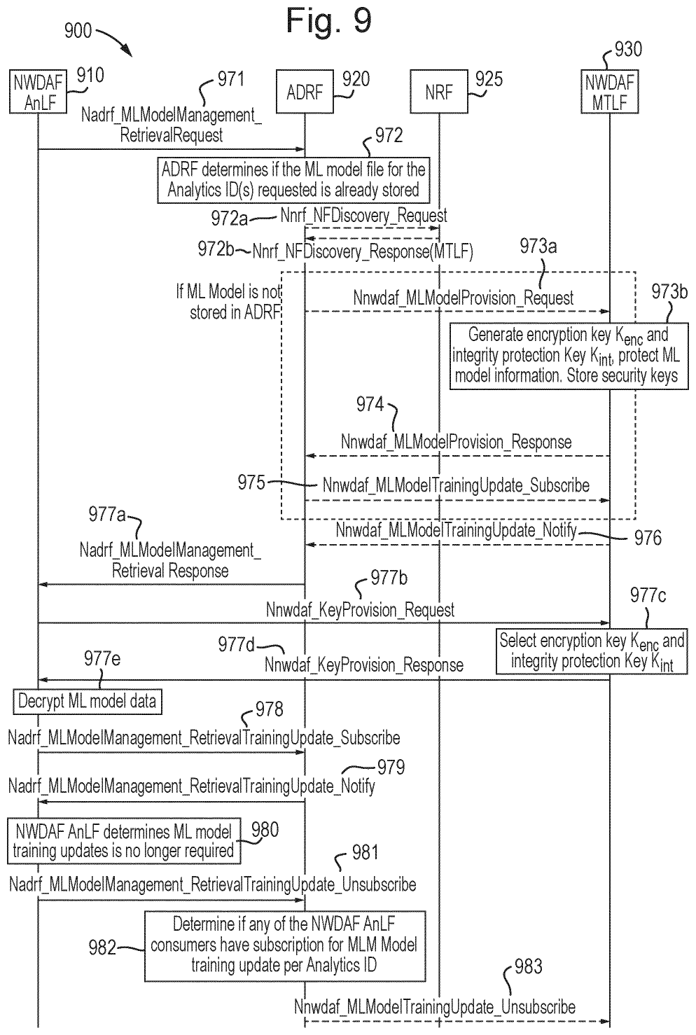

FIG. 9 illustrates an arrangement wherein a security context is generated and stored in an NWDAF containing MTLF. FIG. 9 illustrates a Network Data Analytics Function containing an Analytics logical function (NWDAF AnLF) 910, an Analytics Data Repository Function (ADRF) 920, a Network Repository Function (NRF) 925, and a Network Data Analytics Function containing a Model Training logical function (NWDAF MTLF) 930. The NWDAF MTLF 930 may comprise a network node 300 as described herein.

The method 900 illustrated in FIG. 9 starts at 971, where the NWDAF containing AnLF 910 sends Nadrf_MLModelManagement_RetrievalRequest which includes Analytics ID(s), ML Model Filter Info (ML model file specific information), optionally Target NF (NWDAF containing MTLF) to subscribe for notifications. The ML model file specific information includes the ML model file serialization format requested by the NWDAF containing AnLF 910.

At 972, the ADRF 920 determines if the ML model file for the Analytics ID(s) requested is already stored. This is done by way of the ADRF 920 sending 972a a Nnrf_NFDiscovery_Request to the NRF 925. In response the NRF 925 sends 972b a Nnrf_NFDiscovery_Response message to the ADRF 920, the Nnrf_NFDiscovery_Response message identifying the MTLF. If the ML model file for the Analytics ID(s) requested in not stored in ADRF 920 then step 973, 974, 975, 976 are performed, before these steps, the ADRF 920 discovers the target MTLF from the NRF 925 optionally if it isn't informed by the AnLF 910 in step 971. If the ML model file for the Analytics ID(s) requested in stored in ADRF 920 the steps 973, 974, 975, 976 are skipped.

At 973a, the ADRF 920 sends Nnwdaf_MLModelProvision_Request with the input parameters defined in TS 23.288 and additional input parameters ML model file specific information (ML model file serialization format).

At 973b, the NWDAF containing MTLF 930 generates a security context comprising an encryption key K_{enc} and/or and integrity key Kᵢₙₜ and selects a security algorithm for encryption and/or integrity protection, i.e. either the same algorithm for both, or a different for each, or only for protecting with encryption or integrity. The key generation may be based on algorithms known in the state of the art. The NWDAF containing MTLF 930 uses the encryption key K_{enc} and/or and integrity key Kᵢₙₜ to protect the ML model and/or related information, e.g. ML model file serialization format etc. The MTLF 930 stores the security keys and the related ML information for identification.

At 974, the NWDAF containing MTLF 930 sends a Nnwdaf_MLModelProvision_Response with following parameters Analytics ID(s), Protected Trained ML model file(s), NWDAF containing MTLF 930 address. The NWDAF containing MTLF 930 address maybe the NF identifier of the NWDAF containing MTLF 930, used to authorize another consumer to contact the NWDAF containing MTLF 930 via the NRF 925.

At 975, the ADRF 920 sends Nnwdaf_MLModelTrainingUpdate_Subscribe with the input parameters Analytics ID(s), ML model file specific information (ML model file serialization format).

At 976, when the ML model for which the ADRF 920 has subscribed for ML model training update has been updated, the NWDAF containing MTLF 930 sends Nnwdaf_MLModelTrainingUpdate_Notify with the following parameters Analytics ID, Protected Trained ML model(s) file, Notification Correlation ID, NWDAF containing MTLF address.

At 977a, the ADRF 920 sends a response back to NWDAF containing AnLF 910 using Nadrf_MLModelManagement_Retrieval Response with the following parameters ML Model File Information (Trained ML model(s) file, ML model file serialization format, Trained ML Model ID per Analytics ID, NWDAF containing MTLF address).

At 977b, the NWDAF containing AnLF 910 sends Nnwdaf_KeyProvision_Request to the NWDAF containing MTLF 930 with the input parameters Analytics ID(s), Notification Correlation ID. The NWDAF containing AnLF 910 may be authorized by the NRF 925 to contact the NWDAF containing MTLF 930.

At 977c, the NWDAF containing MTLF 930 selects the security keys based on the related ML information for identification.

At 977d, the NWDAF containing MTLF 930 sends a Nnwdaf_KeyProvision_Response to the NWDAF containing AnLF 910, including the encryption key K_{enc} and/or and integrity key Kᵢₙₜ, security algorithm(s).

At 977e, the NWDAF containing AnLF 910 unprotects the ML model data with the received security keys. The unprotection may comprise a de-encryption.

At 978, the NWDAF containing AnLF 910 subscribes to ADRF 920 using Nadrf_MLModelManagement_RetrievalTrainingUpdate_Subscribe service operation containing input parameters Trained ML Model ID per Analytics ID.

At 979, the ADRF 920 sends a notification to NWDAF containing AnLF 910 using Nadrf_MLModelManagement_RetrievalTrainingUpdate_Notify service operation containing following parameters ML Model File Information (Protected Trained ML model(s) file, ML model file serialization format, Trained ML Model ID per Analytics ID, NWDAF containing MTLF address).

At 980, the NWDAF containing AnLF 910 determines that the ML model training update is no longer required.

At 981, the NWDAF containing AnLF 910 sends Nadrf_MLModelManagement_RetrievalTrainingUpdate_Unsubscribe with Subscription Correlation ID as input parameters.

At 982, the ADRF 920 determines if any of the NF consumer(s) have subscription for ML Model training update per Analytics ID. If none of the NF consumer(s) have subscription for ML model training update per Analytics ID, the ADRF 920 removes the ML model file and ML model file specific information and proceed to step 979.

At 983, the ADRF 920 sends Nnwdaf_MLModelTrainingUpdate_ Unsubscribe to NWDAF containing MTLF 930 with the Subscription Correlation ID as input parameter.

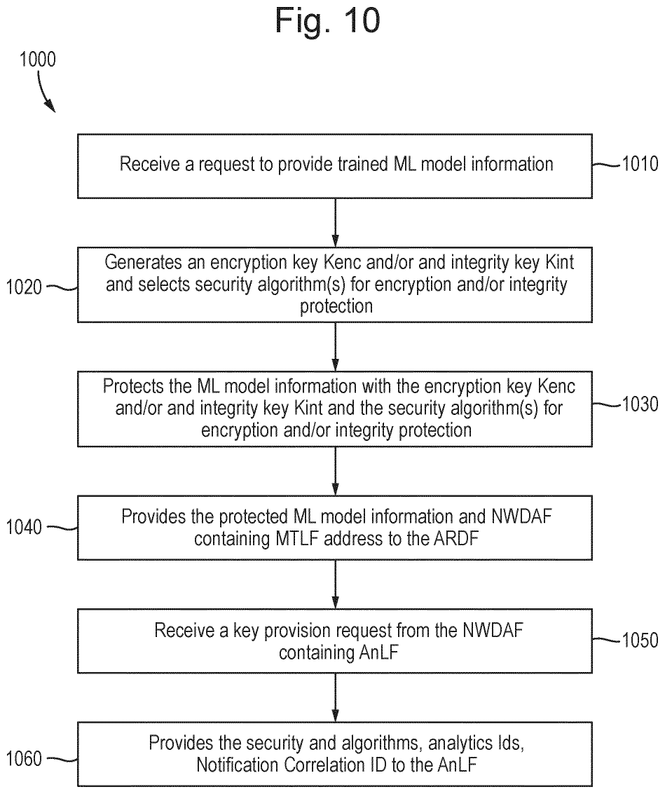

FIG. 10 illustrates a method 1000 of operation of a NWDAF containing MTLF, for example 930 illustrated in FIG. 9. The method 1000 comprises receiving 1010 a request to provide trained ML model information. The method 1000 further comprises generating 1020 an encryption key K_{enc} and/or and integrity key Kᵢₙₜ and selects security algorithm(s) for encryption and/or integrity protection. The method 1000 further comprises protecting 1030 the ML model information with the encryption key K_{enc} and/or and integrity key Kᵢₙₜ and the security algorithm(s) for encryption and/or integrity protection. The method 1000 further comprises providing 1040 the protected ML model information and NWDAF containing MTLF address to the ARDF. The method 1000 further comprises receiving 1050 a key provision request from the NWDAF containing AnLF. The method 1000 further comprises providing 1060 the security keys and algorithms, analytics Ids, Notification Correlation ID to the AnLF.

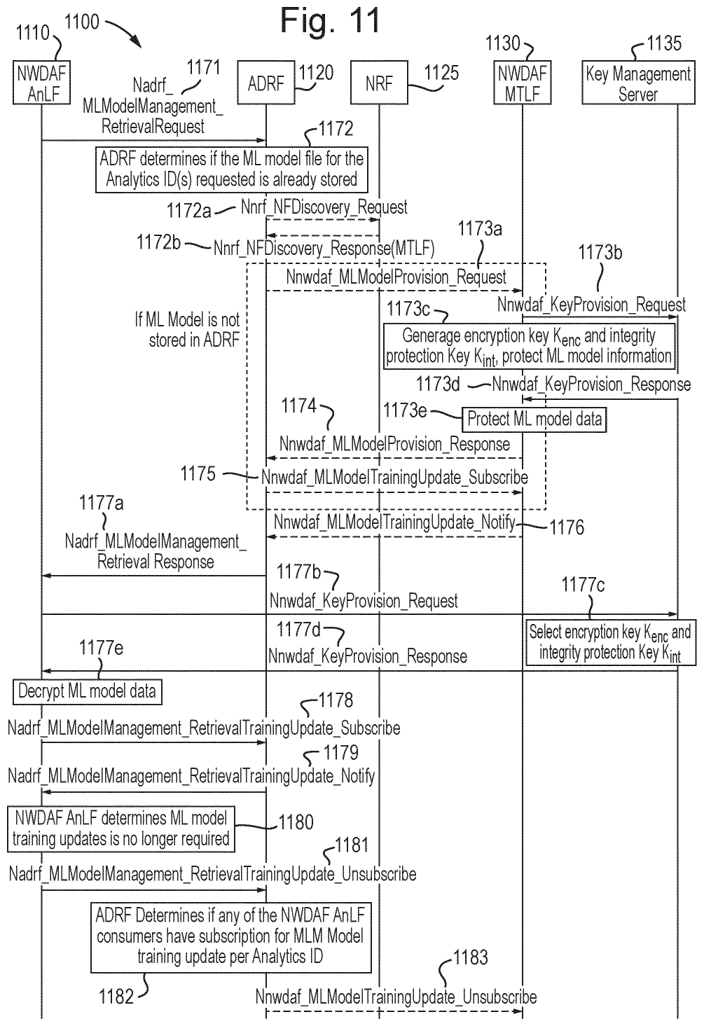

FIG. 11 illustrates a method 1100 wherein a security context is generated by a key management server. FIG. 11 illustrates a Network Data Analytics Function containing an Analytics logical function (NWDAF AnLF) 1110, an Analytics Data Repository Function (ADRF) 1120, a Network Repository Function (NRF) 1125, a Network Data Analytics Function containing a Model Training logical function (NWDAF MTLF) 1130, and a Key Management Sever (KMS) 1135. The NWDAF MTLF 1130 may comprise a network node 300 as described herein.

The method 1100 illustrated in FIG. 11 starts at 1171, wherein the NWDAF containing AnLF 1110 sends Nadrf_MLModelManagement_RetrievalRequest which includes Analytics ID(s), ML Model Filter Info (ML model file specific information), optionally Target NF (NWDAF containing MTLF) to subscribe for notifications. The ML model file specific information includes the ML model file serialization format requested by the NWDAF containing AnLF 1110.

At 1172, the ADRF 1120 determines if the ML model file for the Analytics ID(s) requested is already stored. This is done by way of the ADRF 1120 sending 1172a a Nnrf_NFDiscovery_Request to the NRF 1125. In response the NRF 1125 sends 1172b a Nnrf_NFDiscovery_Response message to the ADRF 1120, the Nnrf_NFDiscovery_Response message identifying the MTLF. If the ML model file for the Analytics ID(s) requested in not stored in ADRF 1120 then step 1173, 1174, 1175, 1176 are performed, before these steps, the ADRF 1120 discovers the target MTLF from the NRF 1125 optionally if it isn't informed by the AnLF 1110 in the step 1171. If the ML model file for the Analytics ID(s) requested in stored in ADRF 1120 the steps 1173, 1174, 1175, 1176 are skipped.

At 1173a, the ADRF 1120 sends Nnwdaf_MLModelProvision_Request with the input parameters defined in TS 23.288 and additional input parameters ML model file specific information (ML model file serialization format).

At 1173b, the NWDAF containing MTLF 1130 sends Nnwdaf_KeyProvision_Request to the KMS 1135 with the input parameters Analytics ID(s), Notification Correlation ID. The KMS 1135 address may be preconfigured in NWDAF containing MTLF 1130 or discovered via NRF 1125.

At 1173c, the KMS 1135 generates a security context comprising an encryption key K_{enc} and/or and integrity key Kᵢₙₜ and selects a security algorithm for encryption and/or integrity protection, i.e. either the same algorithm for both, or a different for each, or only for protecting with encryption or integrity. The key generation may be based on algorithms known in the state of the art. The KMS 1135 stores the security keys and the related ML information for identification.

At 1173d, the KMS 1135 sends a Nnwdaf_KeyProvision_Response to the NWDAF containing MTLF 1130, indicating a successful storage of the information.

At 1173c, the NWDAF containing MTLF 1130 uses the encryption key K_{enc} and/or and integrity key Kᵢₙₜ to protect the ML model and/or related information, e.g. ML model file serialization format etc.

At 1174, the NWDAF containing MTLF 1130 sends a Nnwdaf_MLModelProvision_Response with following parameters Analytics ID(s), Protected Trained ML model file(s), KMS address. The KMS address maybe the NF identifier of the KMS 1135, used to authorize another consumer to contact the KMS 1135 via the NRF 1125.

At 1175, the ADRF 1120 sends Nnwdaf_MLModelTrainingUpdate_Subscribe with the input parameters Analytics ID(s), ML model file specific information (ML model file serialization format).

At 1176, when the ML model for which the ADRF 1120 has subscribed for ML model training update has been updated, the NWDAF containing MTLF 1130 sends Nnwdaf_MLModelTrainingUpdate_Notify with the following parameters Analytics ID, Protected Trained ML model(s) file, Notification Correlation ID, KMS address.

At 1177a, the ADRF 1120 sends a response back to NWDAF containing AnLF using Nadrf_MLModelManagement_Retrieval Response with the following parameters ML Model File Information (Trained ML model(s) file, ML model file serialization format, Trained ML Model ID per Analytics ID, KMS address).

At 1177b, the NWDAF containing AnLF 1110 sends Nnwdaf_KeyProvision_Request to the KMS 1135 with the input parameters Analytics ID(s), Notification Correlation ID. The NWDAF containing AnLF 1110 may be authorized by the NRF 1125 to contact the KMS 1135.

At 1177c, the KMS 1135 selects the security keys based on the related ML information for identification.

At 1177d, the KMS 1135 sends a Nnwdaf_KeyProvision_Response to the NWDAF containing AnLF 1110, including the encryption key K_{enc} and/or and integrity key Kᵢₙₜ.

At 1177e, the NWDAF containing AnLF 1110 unprotects the ML model data with the received security keys. The unprotection may comprise de-encryption.

At 1178, the NWDAF containing AnLF 1110 subscribes to ADRF 1120 using Nadrf_MLModelManagement_RetrievalTrainingUpdate_Subscribe service operation containing input parameters Trained ML Model ID per Analytics ID.

At 1179, the ADRF 1120 sends a notification to NWDAF containing AnLF 1110 using Nadrf_MLModelManagement_RetrievalTrainingUpdate_Notify service operation containing following parameters ML Model File Information (Protected Trained ML model(s) file, ML model file serialization format, Trained ML Model ID per Analytics ID, KMS address).

At 1180, the NWDAF containing AnLF 1110 determines that the ML model training update is no longer required.

At 1181, the NWDAF containing AnLF 1110 sends Nadrf_MLModelManagement_RetrievalTrainingUpdate_Unsubscribe with Subscription Correlation ID as input parameters.

At 1182, the ADRF 1120 determines if any of the NF consumer(s) have subscription for ML Model training update per Analytics ID. If none of the NF consumer(s) have subscription for ML model training update per Analytics ID, the ADRF 1120 removes the ML model file and ML model file specific information and proceed to step 1179.

At 1183, the ADRF 1120 sends Nnwdaf_MLModelTrainingUpdate_Unsubscribe to the NWDAF MTLF 1130 with the Subscription Correlation ID as input parameter.

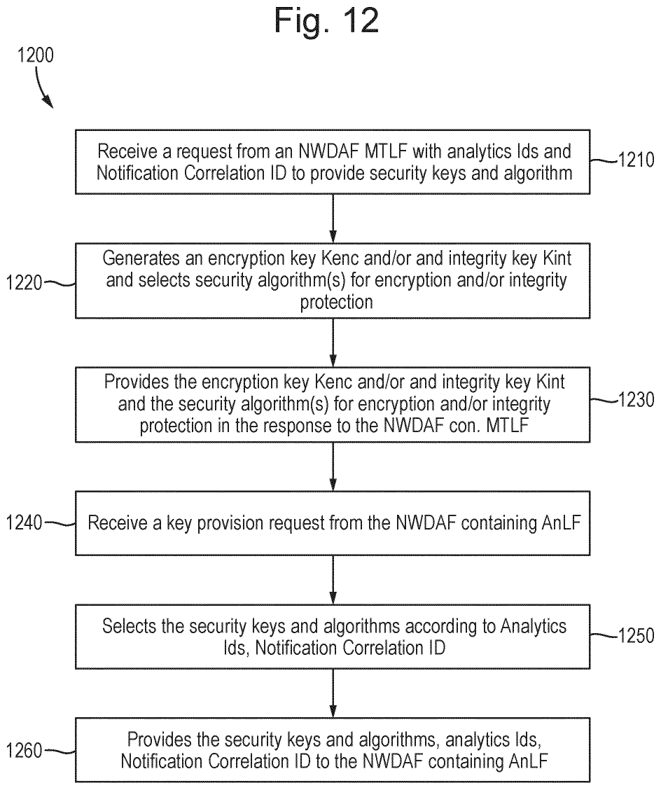

FIG. 12 illustrates a method 1200 of operation of a KMS, for example KMS 1135 illustrated in FIG. 11. The method 1200 comprises receiving 1210 a request from an NWDAF MTLF with analytics Ids and Notification Correlation ID to provide security keys and algorithm. The method 1200 further comprises generating 1220 an encryption key K_{enc} and/or and integrity key Kᵢₙₜ and selects security algorithm(s) for encryption and/or integrity protection. The method 1200 further comprises providing 1230 the encryption key K_{enc} and/or and integrity key Kᵢₙₜ and the security algorithm(s) for encryption and/or integrity protection in the response to the NWDAF MTLF. The method 1200 further comprises receiving 240 a key provision request from the NWDAF containing AnLF. The method 1200 further comprises selecting 1250 the security keys and algorithms according to Analytics Ids, Notification Correlation ID. The method 1200 further comprises providing 1260 the security keys and algorithms, analytics Ids, Notification Correlation ID to the NWDAF containing AnLF.

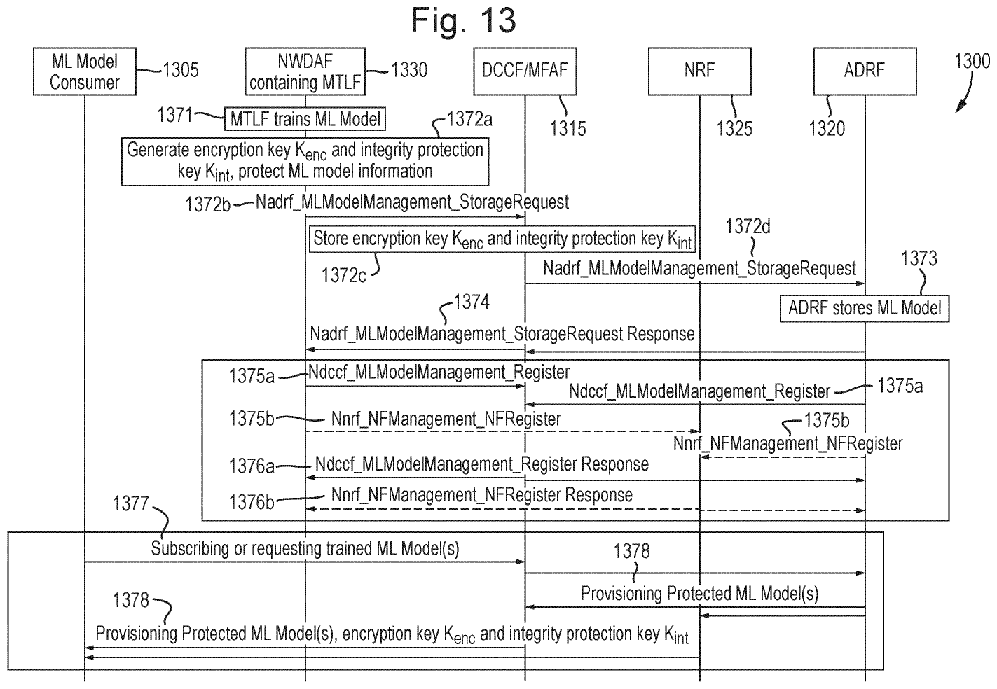

FIG. 13 illustrates a method 1300 wherein a security context is stored at a data collector. The data collector may comprise a Data Collection Coordination Function (DCCF), or a Messaging Framework Adaptor Function (MFAF). FIG. 13 illustrates a consumer 1305 of ML models, a data collector (DCCF/MFAF) 1315 an Analytics Data Repository Function (ADRF) 1320, a Network Repository Function (NRF) 1325, and a Network Data Analytics Function containing a Model Training logical function (NWDAF MTLF) 1330. The NWDAF MTLF 1330, data collector 1315 and NRF 1325 may each comprise a network node 300 as described herein.

The method 1300 begins at 1371, where the NWDAF containing MTLF 1330 instance has the trained ML Model(s).

At 1372a, the NWDAF containing MTLF 1330 generates a security context comprising an encryption key K_{enc} and/or and integrity key Kᵢₙₜ. The key generation may be based on algorithms known in the state of the art. The NWDAF containing MTLF uses the encryption key K_{enc} and/or and integrity key Kᵢₙₜ to protect the ML model and/or related information, e.g. ML model file serialization format etc.

At 1372b, the NWDAF containing MTLF 1330 requests to store the ML Model to the ADRF by invoking the Nadrf_MLModelManagement_StorageRequest (containing the protected trained ML model(s) and/or ML model(s) information, encryption key K_{enc} and/or and integrity key Kᵢₙₜ) service operation or the NWDAF containing MTLF 1330 stores the trained ML Model to the ADRF 1320 via DCCF 1315.

At 1372c, the DCCF 1315 stores the security algorithms, encryption key K_{enc} and/or and integrity key Kᵢₙₜ and ML model related information for identification of the security keys at request from a NFc. The DCCF 1315 forwards the Nadrf_MLModelManagement_StorageRequest (containing the protected trained ML model(s) and/or ML model(s) information) to the ADRF 1320, removing the security keys from the message.

At 1373, the ADRF 1320 stores the trained ML model(s) and/or the ML model(s) information sent by the NWDAF containing MTLF 1330. The ADRF 1320 may be based on implementation, determines whether the same trained ML Model is already stored by the NWDAF containing MTLF 1330. If the trained ML Model is already stored, the ADRF 1320 decides to store again to update the trained ML Model sent by the NWDAF containing MTLF 1330.

At 1374, the ADRF 1320 sends Nadrf_MLModelManagement_StorageRequest Response message to the NWDAF containing MTLF 1330 indicating that the trained ML Model is stored, including when the ADRF 1320 may have determined at step 1373 that the trained ML Model is already stored.

At 1375, the NWDAF containing MTLF 1330 and/or the ADRF 1320 requests to register ML Model profile to DCCF 1315 by invoking the Ndccf_MLModelManagement_Register. Or the NWDAF containing MTLF 1330 and/or the ADRF 1320 registers its ML Model profile to the NRF 1325 by invoking the Nnrf_NFManagement_NFRegister.

The ML Model profile may include one of the following parameters: NWDAF ID, ADRF ID, Analytics ID(s), model framework, model platform,model type, model algorithm, model compilation language, model Spatial validity, model validity period, model accuracy, model space effectiveness, etc. Additionally the NWDAF containing MTLF 1330 may include the encryption key K_{enc} and/or and integrity key Kᵢₙₜ if not already provisioned in step 1372b.

At 1376, the DCCF 1315 responds to the NWDAF containing MTLF 1330 and/or the ADRF 1320 with a Ndccf_MLModelManagement_Register Response. Or the NRF 1325 responds to the NWDAF containing MTLF 1330 and/or the ADRF 1320 with a Nnrf_NFManagement_NFRegister Response.

At 1377, the ML model consumer 1305 (which may be an NWDAF containing AnLF) subscribes or requests a (set of) trained ML Model(s) associated with a (set of) Analytics ID(s) to DCCF 1315 or ADRF 1320. The procedure of NWDAF discovery and selection for trained ML models via NRF is defined in TS 23.288, incorporated herein by reference.

At 1378, the ADRF 1320 or DCCF 1315 notifies the ML model consumer 1305 with the trained ML Model Information (containing a (set of) file address of the protected trained ML model). The DCCF 1315 or NRF 1325 may include the security keys encryption key K_{enc} and/or and integrity key Kᵢₙₜ, security algorithm(s) to the ML model consumer 1305 so that the ML model consumer 1305 can unprotect the ML model information.

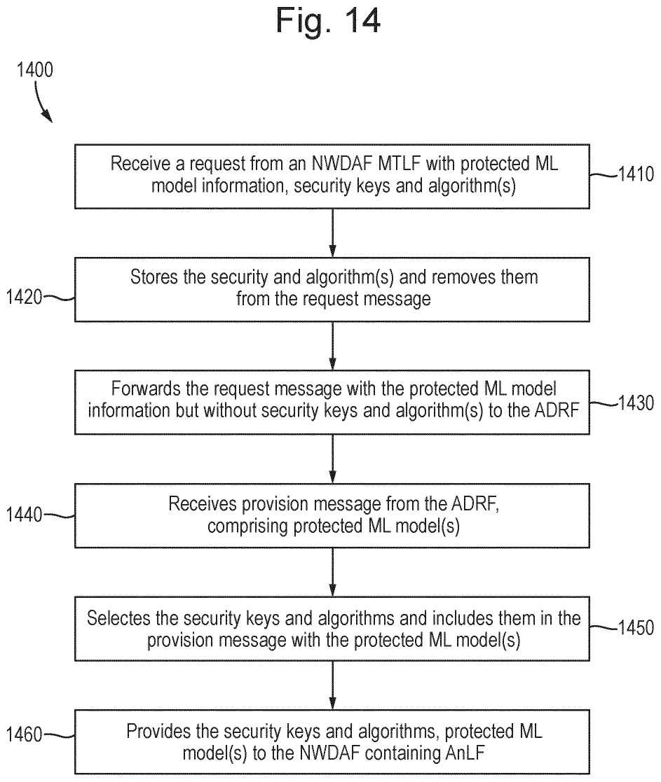

FIG. 14 illustrates a method 1400 of operation of a data collector, for example DCCF/MFAF 1315 or NRF 1325 illustrated in FIG. 13. The method 1400 comprises receiving 1410 a request from an NWDAF MTLF with protected ML model information, security keys and algorithm(s). The method 1400 further comprises storing 1420 the security keys and algorithm(s) and removes them from the request message. The method 1400 further forwarding 1430 the request message with the protected ML model information but without security keys and algorithm(s) to the ADRF. The method 1400 further receiving 1440 provision message from the ADRF, comprising protected ML model(s). The method 1400 further selecting 1450 the security keys and algorithms and includes them in the provision message with the protected ML model(s). The method 1400 further providing 1460 the security keys and algorithms, protected ML model(s) to the NWDAF containing AnLF.

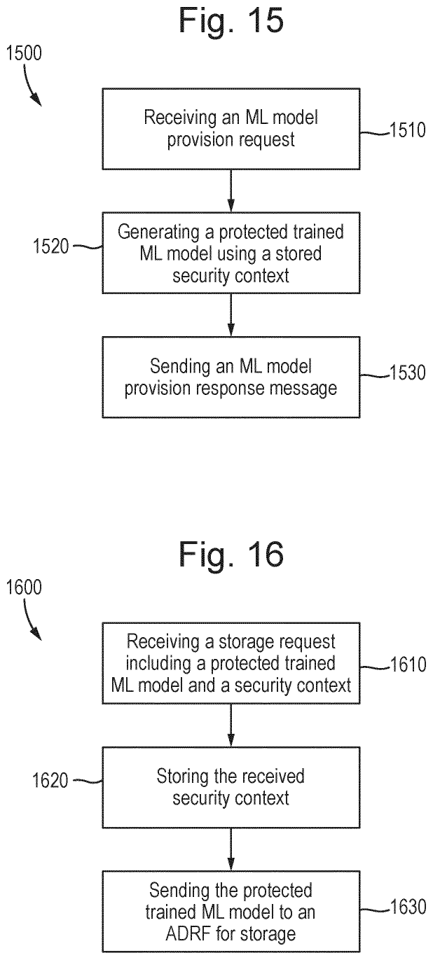

FIG. 15 illustrates a method 1500 in a Network Data Analytics Function containing a Model Training logical function. The method 1500 comprises receiving 1510 a machine learning (ML) model provision request, the ML model provision request comprising: an identifier for at least one Analytic, and, ML model file specific information, and generating 1520 a protected trained ML model using a stored security context. The method 1500 further comprises sending 1530, in response to the ML model provision request, an ML model provision response message, the ML model provision response message comprising: the identifier for the at least one Analytic; at least one protected trained ML model file; and location information of the stored security context.

The security context may comprise encryption information, the encryption information relating to an encryption operation applied to the ML model file. The encryption information may define at least one aspect of an encryption operation applied to the ML model file. The security context may comprise at least one of: the encryption key, integrity key, algorithm for encryption, and/or algorithm for integrity. The ML model provision response message may further comprise a Notification Correlation Identifier.

The method may further comprise generating a security context, wherein the location information of the stored security context is the address of the Network Data Analytics Function containing a Model Training logical function.

The method may further comprise receiving a key provision request from a Network Data Analytics Function containing an Analytics logical function, the key provision request comprising: the identifier for the at least one Analytic; and the ML model file specific information. The method may further comprise selecting the corresponding previously generated security context, and sending to the NWDAF containing an Analytics logical function apparatus, in response to the key provision request, a key provision response message, the key provision response message comprising the selected security context.

The Network Data Analytics Function containing an Analytics logical function may be an apparatus different to the Network Data Analytics Function containing a Model Training logical function.

The method may further comprise generating a security context and storing the generated security context in a Key Management Server. The location information of the stored security context may be the address of the Key Management Server.

The method may further comprise receiving a key provision request from a Network Data Analytics Function containing an Analytics logical function. The key provision request may comprise: the identifier for the at least one Analytic; and the ML model file specific information. The method may further comprise sending to the NWDAF containing an Analytics logical function apparatus, in response to the key provision request, a key provision response message, the key provision response message comprising the address of the Key Management Server.

The Network Data Analytics Function containing an Analytics logical function may be an apparatus different to the Network Data Analytics Function containing a Model Training logical function.

The method may further comprise sending a key provision request to a Key Management Server; and receiving a security context from the Key Management Server. The location information of the stored security context is the address of the Key Management Server.

A subsequent key provision request is sent to the Key Management Server from a Network Data Analytics Function containing an Analytics logical function, the key provision request comprising: the identifier for the at least one Analytic; and the ML model file specific information. In response, the Key Management Server selects the corresponding previously generated security context, and sends to the NWDAF containing an Analytics logical function apparatus, in response to the key provision request, a key provision response message, the key provision response message comprising the selected security context.

The Network Data Analytics Function containing an Analytics logical function is an apparatus different to the Network Data Analytics Function containing a Model Training logical function.

The method may further comprise generating a security context and storing the generated security context in a data collector. The location information of the stored security context may be the address of the data collector.

The data collector may be a Data Collection Coordination Function, or a Messaging Framework Adaptor Function. The data collector sends the protected trained ML model to an Analytics Data Repository Function, the Analytics Data Repository Function stores the protected trained ML model.

In response to a request for the protected trained ML model, the data collector retrieves the stored protected trained ML model from the Analytics Data Repository Function, and sends the protected trained ML model together with the security context. The request for the protected trained ML model may be received from a ML model consumer.

There is further provided a Network Data Analytics Function containing a Model Training logical function and comprising a transceiver and a processor. The transceiver is arranged to receive a machine learning (ML) model provision request, the ML model provision request comprising: an identifier for at least one Analytic, and ML model file specific information. The processor is arranged to generate a protected trained ML model using a stored security context. The transceiver is further arranged to send, in response to the ML model provision request, an ML model provision response message, the ML model provision response message comprising: the identifier for the at least one Analytic; at least one protected trained ML model file; and location information of the stored security context.

The security context may comprise encryption information, the encryption information relating to an encryption operation applied to the ML model file.

The encryption information may define at least one aspect of an encryption operation applied to the ML model file. The security context may comprise at least one of: the encryption key, integrity key, algorithm for encryption, and/or algorithm for integrity.

The ML model provision response message may further comprise a Notification Correlation Identifier.

The processor may be further arranged to generate a security context; wherein the location information of the stored security context is the address of the Network Data Analytics Function containing a Model Training logical function.

The processor may be further arranged to receive a key provision request from a Network Data Analytics Function containing an Analytics logical function, the key provision request comprising the identifier for the at least one Analytic, and the ML model file specific information. The processor may be further arranged to select the corresponding previously generated security context. The transceiver may be further arranged to send to the NWDAF containing an Analytics logical function apparatus, in response to the key provision request, a key provision response message, the key provision response message comprising the selected security context.

The Network Data Analytics Function containing an Analytics logical function may be an apparatus different to the Network Data Analytics Function containing a Model Training logical function.

The processor may be further arranged to generate a security context. The Network Data Analytics Function containing a Model Training logical function may further comprise a local memory arranged to store the generated security context in a Key Management Server. The location information of the stored security context may be the address of the Key Management Server.

The transceiver may be further arranged to receive a key provision request from a Network Data Analytics Function containing an Analytics logical function, the key provision request comprising: the identifier for the at least one Analytic; and the ML model file specific information. The transceiver may be further arranged to send to the NWDAF containing an Analytics logical function apparatus, in response to the key provision request, a key provision response message, the key provision response message comprising the address of the Key Management Server.

The Network Data Analytics Function containing an Analytics logical function may be an apparatus different to the Network Data Analytics Function containing a Model Training logical function.

The transceiver may be further arranged to send a key provision request to a Key Management Server; and to receive a security context from the Key Management Server. The location information of the stored security context may be the address of the Key Management Server.

A subsequent key provision request is sent to the Key Management Server from a Network Data Analytics Function containing an Analytics logical function, the key provision request comprising: the identifier for the at least one Analytic; and the ML model file specific information. In response, the Key Management Server selects the corresponding previously generated security context, and sends to the NWDAF containing an Analytics logical function apparatus, in response to the key provision request, a key provision response message, the key provision response message comprising the selected security context.

The Network Data Analytics Function containing an Analytics logical function is an apparatus different to the Network Data Analytics Function containing a Model Training logical function.

The processor may be further arranged to generate a security context. The Network Data Analytics Function containing a Model Training logical function may further comprise a local memory arranged to store the generated security context in a data collector. The location information of the stored security context is the address of the data collector.

The data collector may be a Data Collection Coordination Function, or a Messaging Framework Adaptor Function. The data collector sends the protected trained ML model to an Analytics Data Repository Function, the Analytics Data Repository Function stores the protected trained ML model. In response to a request for the protected trained ML model, the data collector retrieves the stored protected trained ML model from the Analytics Data Repository Function, and sends the protected trained ML model together with the security context. The request for the protected trained ML model may be received from a ML model consumer.

FIG. 16 illustrates a method 1600 in a data collector. The method 1600 comprises receiving 1610 a storage request from a Network Data Analytics Function containing a Model Training logical function, the storage request comprising a protected trained ML model and a security context used to protect the trained ML model. The method 1600 further comprises storing 1620 the received security context in a local storage; and sending 1630 the protected trained ML model to an Analytics Data Repository Function for storage.

The method may further comprise separating the received protected trained ML model and the security context used to protect the trained ML model. The protected trained ML model is sent to the Analytics Data Repository Function for storage without the security context.

The data collector may be a Data Collection Coordination Function, or a Messaging Framework Adaptor Function.

The method may further comprise receiving a request for the protected trained ML model from a consumer, and retrieving the security context from the local storage. The method further comprises retrieving the stored protected trained ML model from the Analytics Data Repository Function, and sending to the consumer the retrieved protected trained ML model and the retrieved security context.

The consumer may be a ML model consumer.

There is further provided a data collector comprising a transceiver and a local memory. The transceiver is arranged to receive a storage request from a Network Data Analytics Function containing a Model Training logical function, the storage request comprising a protected trained ML model and a security context used to protect the trained ML model. The local memory is arranged to store the received security context. The transceiver is further arranged to send the protected trained ML model to an Analytics Data Repository Function for storage.

The data collector may further comprise a processor arranged to separate the received protected trained ML model and the security context used to protect the trained ML model. The separating may facilitate storing these in different locations. The protected trained ML model is sent to the Analytics Data Repository Function for storage without the security context.

The present document addresses the problem that if there is no protection against accessing and reading an AI/ML model from the ADRF (Analytics Data Repository Function) stored by NFp (NF producer), a compromised ADRF may expose algorithms and sensitive data to a non-authorized entity which can easily misuse it and/or distributed further to other entities, causing a bigger data security breach.

Accordingly, ML model data stored in the ADRF is protected by the NF producer (NWDAF, Network Data Analytics Function, containing MTLF, Model Training Logical Function), the ADRF has no access to the security keys, those are only provided to authorized consumers. Such a consumer may be the NWDAF containing AnLF, Analytics Logical Function.

According to one arrangement described herein, NWDAF MTLF generates the security context, protects the ML model and stores it in the ADRF, provides ML model and security context to the NWDAF AnLF.

According to a further arrangement described herein MTLF receives ML model request, generates the security context, stores the security context in a key management server (KMS) and provides the protected model with KMS address to the ADRF. AnLF queries the KMS for the security context. According to a further arrangement described herein MTLF receives ML model request, generates the security context, stores the security context and provides the protected model with MTLF address to the ADRF. AnLF queries the MTLF for the security context. According to a further arrangement described herein MTLF receives ML model request and queries the KMS for a security context. The KMS generates the security context, stores the security context provides it to the MTLF. The MTLF provides the protected model with KMS address to the ADRF. AnLF queries the KMS for the security context.

According to a further arrangement described herein DCCF/MFAF/NRF receives a protected ML model and security context from the MTLF. DCCF/MFAF/NRF removes the security context, forwards the protected ML model to the ADRF. DCCF/MFAF/NRF receives a provisioning message with protected ML model, adds the security context and forwards to the AnLF. The DCCF/MFAF/NRF may comprise a network node 300, a NRF 625, NRF 935, NRF 1125, NRF 1325 or a DCCF/MFAF 1315 as described herein.

There is provided an apparatus comprising: a transceiver; and a processor coupled to the transceiver. The processor and the transceiver are configured to cause the apparatus to: receive a ML model provision request from a Analytics Data Repository Function (which may be on another apparatus). The ML model provision request comprises: an identifier for Analytic(s), and, ML model file specific information. The apparatus is further caused to generate a security context, the security context comprising of one or more of the parameters encryption key, integrity key, algorithm for encryption, algorithm for integrity. The apparatus is further caused to generate a protected trained ML model using the generated security context; and to send, in response to the ML model provision request to the Analytics Data Repository Function apparatus, a ML model provision response message. The ML model provision response message comprises: the identifier for Analytic(s); the protected Trained ML model file(s); the Notification Correlation Identifier; and the address of the apparatus [which may be the NWDAF containing MTLF]. The apparatus is further caused to receive a key provision request from a NWDAF containing AnLF (which may be on another apparatus). The key provision request comprises an identifier for Analytic(s), and, ML model file specific information. The apparatus is further caused to select the corresponding previously generated security context comprising of one or more of the parameters encryption key, integrity key, algorithm for encryption, algorithm for integrity; and to send, in response to the key provision request to the NWDAF containing AnLF apparatus, a key provision response message, the key provision response message comprising the selected security context.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are used in the field of the present document. ADRF Analytics Data Repository Function; AI Artificial Intelligence; ML Machine Learning; NFp NF producer; NFc NF consumer; NWDAF Network Data Analytics Function; MTLF Model Training logical function; AnLF Analytics logical function; MFAF Managing Framework Adaptor Function; DCCF Data Collection Coordination Function; NRF Network Function Repository Function; and KMS Key Management Server.

1. A method performed by a Network Data Analytics Function containing a Model Training logical function, the method comprising:
receiving a machine learning (ML) model provision request, the ML model provision request comprising: an identifier for at least one Analytic, and, ML model file specific information;
generating a protected trained ML model using a stored security context; and
sending, in response to the ML model provision request, an ML model provision response message, the ML model provision response message comprising:
the identifier for the at least one Analytic;
at least one protected trained ML model file; and
location information of the stored security context.

2. The method of claim 1, wherein the security context comprises encryption information, the encryption information relating to an encryption operation applied to the ML model file.

3. The method of claim 1, further comprising:
generating the security context;
wherein the location information of the stored security context is an address of the Network Data Analytics Function containing the Model Training logical function.

4. The method of claim 3, further comprising:
receiving a key provision request from a Network Data Analytics Function (NWDAF) containing an Analytics logical function, the key provision request comprising:
the identifier for the at least one Analytic; and
the ML model file specific information;
selecting a corresponding previously generated security context; and
sending to the NWDAF containing Analytics logical function, in response to the key provision request, a key provision response message, the key provision response message comprising the selected security context.

5. The method of claim 4, wherein the Network Data Analytics Function containing the Analytics logical function is an apparatus different to the Network Data Analytics Function containing the Model Training logical function.

6. The method of claim 1, further comprising:
generating a security context; and
storing the generated security context in a Key Management Server;
wherein the location information of the stored security context is an address of the Key Management Server.

7. The method of claim 6, further comprising:
receiving a key provision request from a Network Data Analytics Function (NWDAF) containing an Analytics logical function, the key provision request comprising:
the identifier for the at least one Analytic; and
the ML model file specific information; and
sending to the NWDAF containing an Analytics logical function apparatus, in response to the key provision request, a key provision response message, the key provision response message comprising the address of the Key Management Server.

8. The method of claim 7, wherein the Network Data Analytics Function containing the Analytics logical function is an apparatus different to the Network Data Analytics Function containing the Model Training logical function.

9. The method of claim 1, further comprising:
sending a key provision request to a Key Management Server; and
receiving a security context from the Key Management Server;
wherein the location information of the stored security context is an address of the Key Management Server.

10. The method of claim 1, further comprising:
generating a security context; and
storing the generated security context in a data collector;
wherein the location information of the stored security context is an address of the data collector.

11. The method of claim 10, wherein the data collector is a Data Collection Coordination Function, or a Messaging Framework Adaptor Function.

12. A Network Data Analytics Function containing a Model Training logical function and comprising:
at least one memory; and
at least one processor coupled with the at least one memory and configured to cause the Network Data Analytics Function containing the Model Training logical function to:
receive a machine learning (ML) model provision request, the ML model provision request comprising: an identifier for at least one Analytic and ML model file specific information;
generate a protected trained ML model using a stored security context; and
send, in response to the ML model provision request, an ML model provision response message, the ML model provision response message comprising:
the identifier for the at least one Analytic;
at least one protected trained ML model file; and
location information of the stored security context.

13. The Network Data Analytics Function containing a Model Training logical function of claim 12, wherein the security context comprises encryption information, the encryption information relating to an encryption operation applied to the ML model file.

14. The Network Data Analytics Function containing a Model Training logical function of claim 12, wherein the at least one processor is further configured to cause the Network Data Analytics Function containing the Model Training logical function to generate a security context; and wherein the location information of the stored security context is an address of the Network Data Analytics Function containing the Model Training logical function.

15. The Network Data Analytics Function containing a Model Training logical function of claim 14, wherein:
the at least one processor is further configured to cause the Network Data Analytics Function containing the Model Training logical function to: receive a key provision request from a Network Data Analytics Function (NWDAF) containing an Analytics logical function, the key provision request comprising the identifier for the at least one Analytic and the ML model file specific information;
select a corresponding previously generated security context; and
send to the NWDAF containing an Analytics logical function, in response to the key provision request, a key provision response message, the key provision response message comprising the selected security context.

16. A method performed by a data collector, the method comprising:
receiving a storage request from a Network Data Analytics Function containing a Model Training logical function, the storage request comprising a protected trained ML model and a security context used to protect the trained ML model;
storing the received security context in a local storage; and
sending the protected trained ML model to an Analytics Data Repository Function for storage.

17. The method of claim 16, wherein the data collector is a Data Collection Coordination Function or a Messaging Framework Adaptor Function.

18. The method of claim 16, further comprising:
receiving a request for the protected trained ML model from a consumer;
retrieving the security context from the local storage;
retrieving the stored protected trained ML model from the Analytics Data Repository Function; and
sending to the consumer the retrieved protected trained ML model and the retrieved security context.

19. A data collector, comprising
at least one memory; and
at least one processor coupled with the at least one memory and configured to cause the data collector to:
receive a storage request from a Network Data Analytics Function containing a Model Training logical function, the storage request comprising a protected trained ML model and a security context used to protect the trained ML model;
store the received security context; and
send the protected trained ML model to an Analytics Data Repository Function for storage.

20. The data collector of claim 19, wherein the data collector is a Data Collection Coordination Function or a Messaging Framework Adaptor Function.
